(19) United States
(12) Patent Application Publication
(10) Pub. No.: US 2026/0222823 A1
(43) Pub. Date: Jul. 30, 2026

(54) RESEQUENCING DELAYED LAWFUL INTERCEPTION DATA

(71) Applicant: Telefonaktiebolaget LM Ericsson (publ), Stockholm (SE)

(72) Inventors: Tiziana Bellavista, GAETA (LT) (IT); Domenico Raffaele Cione, Caserta (IT); Mario Ascione, Torre del Greco (NA) (IT)

(21) Appl. No.: 19/150,354

(22) PCT Filed: Feb. 10, 2023
(86) PCT No.: PCT/SE2023/050112

§ 371 Date: Jul. 23, 2025

(51) Int. Cl. H04W 12/80; H04W 36/00

(52) U.S. Cl. CPC H04W 12/80; H04W 36/0038

(57) ABSTRACT

A method for resequencing delayed Lawful Intercept (LI) data before handing the LI data over to a Law Enforcement Monitoring Facility (LEMF) of a Law Enforcement Agency (LEA). LI data that is associated with a communication session of a communication service is received from a Point of Interception (Pol) associated with the communication service, and when triggering event occurs, the LI data is buffered by a Delayed Data Delivery Function (DDDF) until another triggering event occurs. The triggering events can be specific events, or in response to determining that a message of the LI data is received out of sequence or in sequence with respect to a service manifesto associated with the communication service. The buffered data is resequenced by a Handover Manager (HM) and then handed over to the LEMF.

### TECHNICAL FIELD

The present disclosure relates to lawful intercept data, and more specifically to resequencing delayed lawful intercept data in a communications system.

### BACKGROUND

Lawful Interception (LI) Handover Interfaces (HI) via Internet Protocol (IP) based networks are specified by European Telecommunications Standards Institute (ETSI) Technical Specification (TS) 102 232 parts 1 [ETSI TS 102 232-1 V.3.27.1 (2022-08)], 2 [ETSI TS 102 232-2 V3.14.1 (2022-04)], 3 [ETSI TS 102 232-3 V3.9.1 (2020-11)], 4 [ETSI TS 102 232-4 V3.4.1 (2017-08)], 5 [ETSI TS 102 232-5 V3.16.1 (2022-08)], 6 [ETSI TS 102 232-6 V3.3.1 (2014-03)], and 7 [ETSI TS 102 232-7 V3.12.1 (2022-08)] defining Intercept Related Information (IRI) and Contents of Communication (CC) contents per each intercepted service (e.g. Messaging services, L2 services, Internet Access Service, IP Multimedia and Mobile services).

TS 102 232-1 defines the general aspects of the Handover Interface 2 (HI2) and HI3 interfaces between the Communications Service Provider (CSP) and the Law Enforcement Agency (LEA) domains (e.g., headers to be added to IRI and CC, protocols and protocol profiles for the handover interface). The CSP is requested to deliver IRI and CC data by gathering it per Lawful Interception Identifier (LIID), Communication Identifier (CID) and Payload Type (i.e., IRI, CC type).

Currently, the CSP domain is in charge of intercept and delivery data whilst the LEA domain is in charge of processing intercepted data received by the CSP. TS 102 232-1 defines two main functions in the CSP domain to manage the intercepted data: Handover Manager (HM) and Delivery Function (DF). The HM task is to handover intercepted data of all running interceptions to the appropriate destination(s) and the HM default setting is to establish a single DF for each Law Enforcement Monitoring Facility (LEMF).

Increasing numbers of LEAs are requesting CSPs (including HM and DF of TS 102 232-1) to guarantee HI Protocol Data Unit (PDU) delivery aligned to the original signaling and PDU data sequences as generated within the interception domain.

On the other side, several CSPs have been requested to cover with high priority particular services interception scenarios (i.e., call forwarding use cases) with ad hoc solutions applicable only to a limited identified series of service cases.

ETSI's Technical Committee on Lawful Intercept (TC LI) has started a broad evaluation on HI PDU sequencing delivery aspects by initially clarifying the HI sequence number setting at the Mediation and Delivery Function (MDF) level. Coming analysis is expected for a solution allowing HI PDU delivery aligned to the Point of Interception (POI) signaling and PDU data sequences starting from the current standard specifications where ETSI does not recommend using the payload timestamp for sequencing PDUs at the LEMF Gateway (LGW) side (clause 5.2.6 of TS 102 232-1) and the current definition of the HI sequence number (clause 5.2.5 of TS 102 232-1) covers only the PDU sequencing order on the delivery link CSP-LEA without any guarantee on the PDU time of interception sequencing for LEA.

An extensive LI solution should involve several PoIs in the CSP domain for the same intercepted network service. Each PoI provides interception data over X interface with its own sequence number and time of interception. MDF may receive for the same intercepted service, several data from different PoIs towards respective X interfaces. MDF is in charge to process LI data received by the PoIs, assigns a sequence number along with other information and delivers the processed data to LEA towards H interface. MDF processes LI data as soon as possible. Some delay may occur in relation to any lack/failure of resources needed to deliver data to LEMF or for specific scenario (e.g., diverted VoLTE service).

Current standard LI solutions are allowed to provide delayed data delivery but essentially in relation to any lack/failure of resources needed to delivery data to LEMF. FIG. 1 reports a concrete network scenario where more PoIs 106-1 to 106-3 (collectively, 106) are involved for the same intercepted communication service from Network functions 104-1 to 104-3 (collectively, 104) in a CSP 102. The MDF 108 forwards over an HI interface the received PDU from several PoIs 106 in a sequence order not aligned with the intercepted service logic. It's completely up to the LEMF 110 to rebuild the logic from all data received on HI interface (data that are duplicated and out of sequence.

The data received by the LEMF 110 on H interface is out of order and out of service sequence. On the LEA domain therefore, there can be a post-processing phase to rebuild the intercepted network scenario.

Some LEAs use the time stamp in the HI Header to reorder the data, but this solution is not recommended by ETSI standard (TS 102 232-1 clause 5.2.6 Note 4). The current HI sequence number is used by LEA to detect any missing data (TS 102 232-1 clause 5.2.5) and it cannot be used to reorder the data according to the sequence order generated at PoI level. Moreover, the sequence number on H interface (TS 102 232-1 clause 5.2.5) is generated by MDF 108 without any relation with sequence numbers received over X interface (ETSI TS 103 221-1 V1.12.1 (2022-08) clause 5.3.9).

In addition, specific services signaling management may require the processing of events that are received at a later time interval to get a suitable HI2 data delivery to LEA. FIGS. 2 and 3 provide examples of how call forwarding services can cause LI data provided to an LEMF to become unordered, and that the MDF processing on specific signaling events does not guarantee the service sequence order on HI interface.

In FIG. 2, device 202 gives up on the call before device 208 answers (sends a 200 OK response). Device 202 sends a CANCEL (F9) to proxy 204 since no final response had been received from device 208. If a 200 OK, in response to the INVITE, sent by device 208 to proxy 206 had crossed with the CANCEL, device 202 would have sent an ACK then a BYE to device 208 via proxy 206 and 208 in order to terminate the call. Note that the CANCEL message is acknowledged with a 200 OK on a hop-by-hop basis, rather than end to end.

Advanced MDF implementation will act by waiting for further following events before any processing, e.g., not managing soon 487 signaling which is used by the MDF to wait for coming signaling event to decide if maintaining CIN for communication session. In this case, the ACK F18 message would be provided on the HI interface before the 487 F17 message resulting in erroneous call reconstruction at the LEA domain in case the LEA processing phase is not based on PS-Header time stamp or sequence number parameter.

In FIG. 3, device 306 has a configuration such that calls from device 302 to device 306 are forwarded to device 308 if device 306 does not answer the call (information is known to the proxy server 304). In this case, device 302 calls device 306 and no one answers. The proxy server 304 then places the call to device 308.

Advanced MDF implementation will act by waiting for further following events before any processing, e.g., not managing soon 487 signaling which is used by the MDF to wait for coming signaling event to decide if maintaining CIN for communication session. In this case, an ACK F9 message is provided on HI interface before 487 F8 massage resulting in an erroneous call reconstruction in case the LEA processing phase is not based on PS-Header time stamp or sequence number parameter.

A Delayed Data Delivery Function (DDDF) was described in International Application No. PCT/EP2021/073889, filed on Aug. 30, 2021 that provided a delivery logic in the HM that buffers data if delivery from a CSP is delayed, but the buffered data may still be out of sequence, and thus difficult for the LEA to process and reconstruct.

### SUMMARY

An object of the present disclosure is to enable an improved handling of Lawful Interception (LI) data by e.g., enabling LI in more complex interception domain scenarios.

The present disclosure provides a method for resequencing delayed LI data before handing the LI data over to a Law Enforcement Monitoring Facility (LEMF) of a Law Enforcement Agency (LEA). LI data that is associated with a communication session of a communication service is received from a Point of Interception (PoI) associated with the communication service, and when triggering event occurs, the LI data is buffered by a Delayed Data Delivery Function (DDDF) until another triggering event occurs. The triggering events can be specific events, or in response to determining that a message of the LI data is received out of sequence or in sequence with respect to a service manifesto associated with the communication service. The buffered data can be resequenced by a Handover Manager (HM) and then handed over to the LEMF.

In an embodiment, a method is implemented in an HM of a core network and comprise steps for handing over LI data to a LEMF of a LEA. The method can include receiving LI data comprising information about a plurality of events associated with a communication session of a communication service, from one or more POI. The method can also include determining that a start triggering event has occurred based on the LI data. The method can also include resequencing the plurality of events of the buffered LI data based on a service manifesto associated with the communication service, resulting in resequenced buffered LI data. The method can also include handing over the resequenced buffered LI data to the LEMF.

In an embodiment, a network node is provided to implement a handover manager for a core network, and is configured to hand over LI data to a LEMF of an LEA. The network node can include processing circuitry configured to cause the network node to receive LI data comprising information about a plurality of events associated with a communication session of a communication service, from one or more PoI. The processing circuitry can also cause the network node to determine that a start triggering event has occurred based on the LI data. The processing circuitry can also cause the network node to resequence the plurality of events of the buffered LI data based on a service manifesto associated with the communication service, resulting in resequenced buffered LI data. The processing circuitry can also cause the network node to hand over the resequenced buffered LI data to the LEMF.

In another embodiment, a non-transitory computer-readable storage medium that includes executable instructions to cause a processor device of a network node implementing a handover manager of a core network to receive LI data comprising information about a plurality of events associated with a communication session of a communication service, from one or more PoI. The processor device can also determine that a start triggering event has occurred based on the LI data. The processor device can also buffer the LI data resulting in buffered LI data until a stop triggering event has occurred. The processor device can also resequence the plurality of events of the buffered LI data based on a service manifesto associated with the communication service, resulting in resequenced buffered LI data. The processor device can also hand over the resequenced buffered LI data to an LEMF.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the traditional method of providing Lawful Intercept (LI) data to a Law Enforcement Agency (LEA).

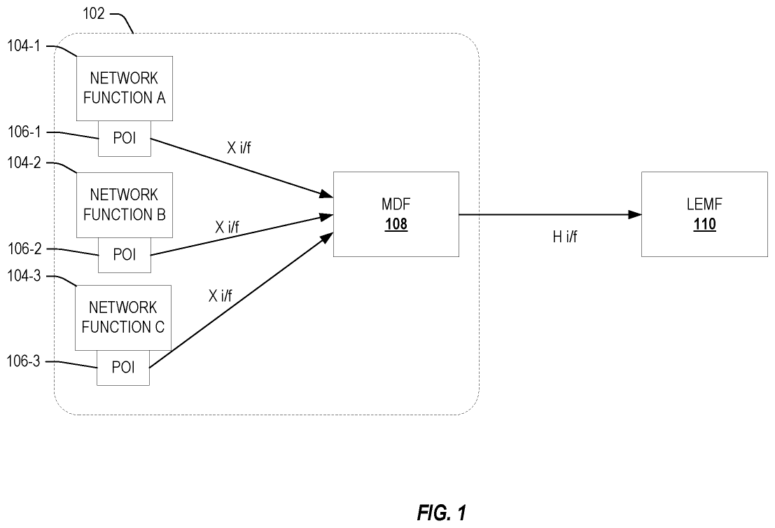

FIG. 2 illustrates a scenario where LI data transferred to an LEA may be out of sequence.

FIG. 3 illustrates another scenario where LI data transferred to an LEA may be out of sequence.

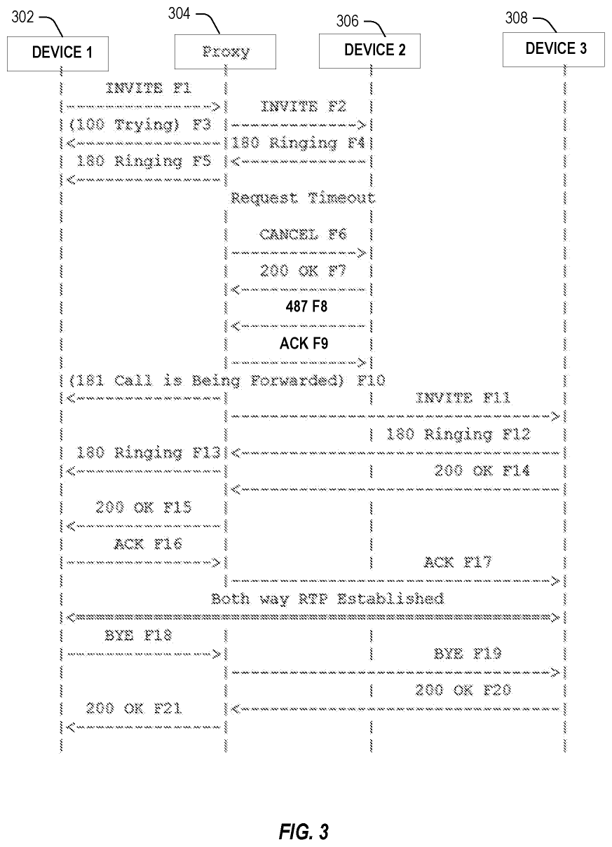

FIGS. 4A and 4B illustrate an exemplary message sequence chart and exemplary service manifesto for a communication service according to some embodiments of the present disclosure.

FIG. 5 illustrates a handover manager (HM) and a Delayed Data Delivery Function (DDDF) in a LI architecture according to some embodiments of the present disclosure.

FIG. 6 illustrates a table of triggering events for network services according to some embodiments of the present disclosure.

FIG. 7 illustrates a message sequence chart for LI data resequencing and handover according to some embodiments of the present disclosure.

FIG. 8 illustrates one example of a cellular communications system according to some embodiments of the present disclosure.

FIGS. 9 and 10 illustrate example embodiments in which the cellular communication system of FIG. 8 is a Fifth Generation (5G) System (5GS).

FIG. 11 is a schematic block diagram of a network node according to some embodiments of the present disclosure.

FIG. 12 is a schematic block diagram that illustrates a virtualized embodiment of the network node of FIG. 11 according to some embodiments of the present disclosure.

FIG. 13 is a schematic block diagram of the network node of FIG. 11 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Network Node: As used herein, a “network node” can be any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Note that the description given herein focuses on a Third Generation Partnership Project (3GPP) cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

The present disclosure provides a method and system for resequencing delayed Lawful Intercept (LI) data before handing the LI data over to a Law Enforcement Monitoring Facility (LEMF) of a Law Enforcement Agency (LEA). LI data that is associated with a communication session of a communication service is received from a Point of Interception (POI) associated with the communication service, and when triggering event occurs, the LI data is buffered by a Delayed Data Delivery Function (DDDF) until another triggering event occurs. The triggering events can be specific events, or in response to determining that a message of the LI data is received out of sequence or in sequence with respect to a service manifesto associated with the communication service. The buffered data can be resequenced by a Handover Manager (HM) and then handed over to the LEMF.

Some of the advantages of the method and systems disclosed herein are that the LEA has the ability to configure and activate on demand the buffering and resequencing functionality disclosed herein by extending (in backward compatibility mode) the ETSI LI interfaces Handover Interface 1 (HI1) (Communications Service Provider (CSP)-LEA) and X1 (Administrative Function (ADMF)-Mediation and Delivery Function (MDF)).

Another advantage to the CSP of the present disclosure is that a comprehensive solution to all LEA requests is provided including those LEAs which have no complete (e.g., valid for all network service scenarios) post-processing implementation on place to re-order the HI Protocol Data Units (PDU) received on HI. This can be applied in current and further interception services. Furthermore, another advantage is a more complete interception solution (to be proposed in the ETSI specifications) that can be applied in both 4G, 5G and any further networks (i.e., Cloud network) with no impacts on existing internal intercepting nodes. The proposed solution can be configured to be compliant to different regulations and customer needs. Additionally, an advantage for an LEA is that LEA can use the new function to accomplish the need to process received intercepted data over HI in fast time processing avoiding packet reordering on PS-Header timestamp or sequence number.

The main advantages provided by the method and systems to resequence delayed LI data are:
guaranteeing the sequence of signaling events on HI interface as the same of service intercepted at PoI side;
relying on a standard and backward compatible solution.

In the present disclosure, it is proposed to introduce a new delivery logic in the HM based on a decision mechanism on how to build delivery message sequence towards H interface for signaling interception of an Internet Protocol Multimedia Subsystem (IMS) service (e.g., communication service).

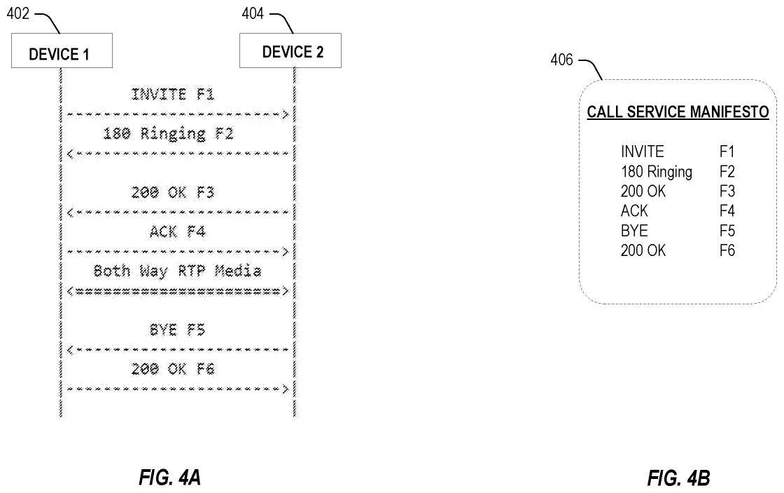

Each communication service can have an associated service manifesto that contains a list of expected events and relative sequence as reported in related RFCs like RFC 3665. FIG. 4A depicts a message sequence chart of a successful session establishment between device 402 and device 404, and FIG. 4B depicts a service manifesto 406 associated with a basic call service. It is to be appreciated that while service manifesto 406 as shown in FIG. 4B is a call service manifesto, other communication services can have their own respective service manifestos that contain different lists of events and sequences of events.

In an embodiment, a service manifesto can comprise a common part that is shared by several network services and a custom part describing the specific service characteristics.

The new mechanism is activated on specific triggering events that delay the decision to all subsequence's events on the same interception scenario for a specific short configurable time interval.

For this reason, the proposed HM can use the DDDF function to implement a buffer and delay mechanism. The LI data is buffered when out of sequence steps are expected to be delivered. Once all the LI data associated with the out of sequence message are received, the HM can resequenced the messages and/or events/steps of the LI data, and then facilitate the handover of the LI data to the LEA. This can enable the LEA to properly reconstruct the events of the intercepted communication session for those LEAs that process LI data based on the service interception order.

The HM can activate an instance of DDDF module based on a warrant definition or based on the service type or a combination of both when a triggering event is detected. Optionally a new parameter “service_sequence_order” can be provided on HI interface to notify LEA the occurred service reordering.

HM uses DDDF functions for two main purposes:
1. Buffer all subsequence events received for an intercepted call after the first triggering event.
2. Order the sequence of events according to the service manifesto.

The solution is applicable to all standard network domains also covering 5G architectures as being defined by 3GPP TS 33 127 V18.1.0 (2022-09) which refers to ETSI for the X and H Interfaces definition.

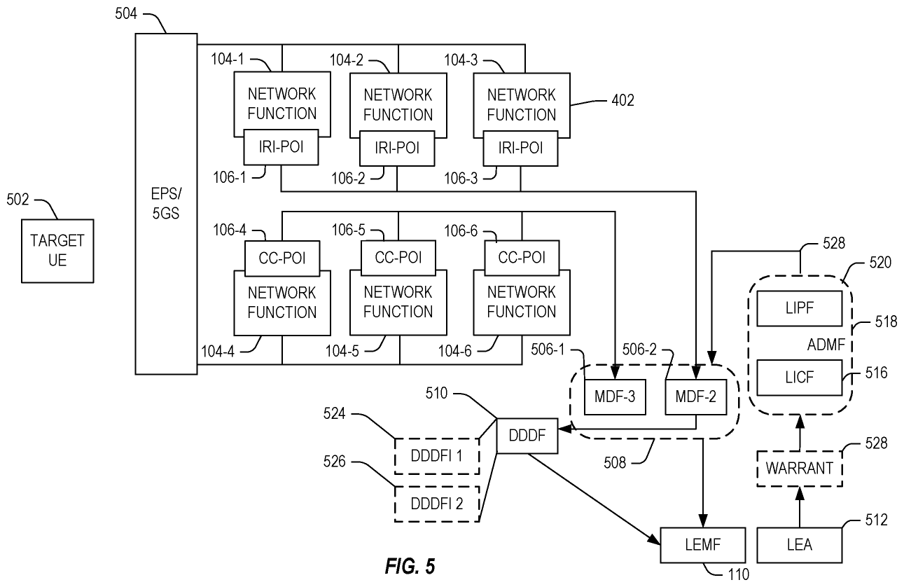

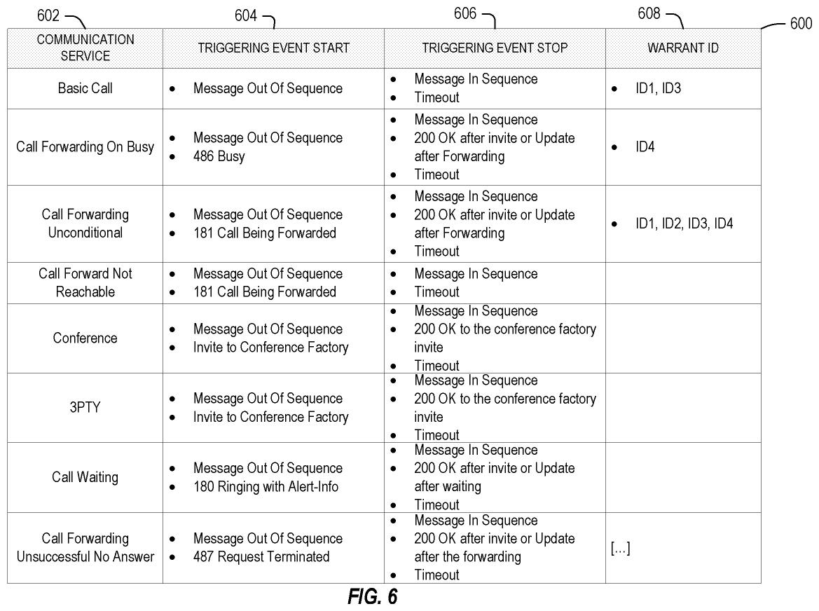

FIG. 5 is depiction of a HM 508 and a DDDF 510 in a LI architecture according to some embodiments of the present disclosure. FIG. 5 is adapted from FIGS. 6.6-1 of the EPS/5GS-Anchored LI architecture in 3GPP TS 33 127 V18.1.0 (2022-09) along with the DDDF 510 and HM 508 represented by MDF2 506-2 and MDF3 506-1

In FIG. 5, an LEA 512 can issue a warrant 528 to lawfully intercept data associated with one or more communications of a target user equipment (UE) 502 that is the subject of the warrant 528. The target UE 502 can send communication data to and from a wireless communications system 504 that has a plurality of network functions 104-1-104-6 (collectively, 104). The network functions 104 can manage and/or facilitate communications with the target UE 502, and different network functions 104 can be associated with different communication services (e.g., calls, data, etc.). Each network function 104 can have a related PoI 106 where the LI data can be intercepted. The PoI can include Intercept Related Information (IRI)-PoI (e.g., POI 106-1, 106-2, and 106-3), and Contents of Communication (CC)-PoI (e.g., PoI 106-4, 106-5, and 106-6). LI data from IRI-POI is managed by mediation and delivery function (MDF)-2 506-2, and LI data from CC-POI is handled by MDF-3 506-1, where MDF-2 506-2 and MDF-3 506-1 are modules of the HM 508.

In an embodiment, the HM 508 can handle a plurality of incoming LI data streams from one or more different communication services simultaneously. The DDDF 510 can buffer the LI data in separate DDDF instances (DDDFI) (e.g., DDDFI 1 524, and DDDF 2 526). After the HM 508 has resequenced the buffered data, the HM 508 can facilitate the transfer of the buffered and resequenced LI data to the LEMF 110 of the LEA 512.

Administrative Function (ADMF) 518 is configured with the list of all network services manifesto for the specific CSP domain and relative triggering events. The new logic foresees two types of triggering events, one to activate the logic and another one to disable it. The ADMF 518 comprises a Lawful Interception Provisioning Function (LIPF) 520 and a Lawful Interception Control Function (LICF) 516. The LICF 516 can receive the warrant 528 from the LEA 512, and the LIPF 520 can control the PoI 106 and configure them to start intercepting data based on the contents of the warrant. The contents of the warrant can specify an identity of the target UE 502 or user associated with the target UE 502, as well as include information about the types of communication services to be intercepted, as well as any other information such as timing, types of data, etc. In an embodiment, the warrant can include a Lawful Interception Identifier (LIID) that is a component of the CC delivery procedure and of the IRI records. It can be used within any information exchanged at the Handover Interfaces HI2 and HI3 for identification and correlation purposes. The LIID format can comprise of alphanumeric characters (or digit string for subaddress option, see annex E). It might for example, among other information, contain a lawful authorization reference number, and the date, when the lawful authorization was issued.

The new delivery logic in HM is intended to be applicable to all network services list for which the manifesto has been defined. The network list can be updated in the CSP domain according to the network evolution by adding new services.

In an embodiment, the HM 508 is able to recognize the communication service based on correlation info received by a PoI 106 on X interface from the LIPF 520 and to generate a communication identification number (CIN) for that session.

FIG. 6 illustrates a table of triggering events for communication services 602 according to some embodiments of the present disclosure. The triggering events include start triggering events 604 and stop triggering events 606 that trigger the HM 508 to start and stop buffering LI data. The start triggering events generally include for each communication service (e.g., basic call, call forwarding on busy, call forwarding unconditional, call forward not reachable, 3PTY, conference, call waiting, and call forwarding unsuccessful no answer) messages being received out of sequence or other specific types of messages that may indicate that messages will be out of sequence if delivered to the LEMF 110 without buffering. The HM 508 can determine whether the messages are out of sequence based on the relevant service manifesto 406 associated with each communication service.

In order to guarantee the backward compatibility, the logic to buffer is deactivated by default, and it is activated on warrant basis at target creation or for a specific network service. ADMF 518 enriches the table by adding the warrant identifier 608, which can include target information (internal identifier that the HM 508 uses to recognize the target).

Information in FIG. 6 is used by ADMF 518 in order to activate and deactivate DDDF 510 for the specific warrant and HM 508 uses it upon the receiving of triggering event for the specific network service.

For each session, the new logic in the HM 508 foresees that MDF 506 uses a state machine to evaluate an X2 packet against triggering events. When a start triggering event is detected, MDF 506 creates a DDDF instance (e.g., DDDFI 524 or 526) providing the appropriate manifesto. At this stage the tuple [DDDF instance; cin; manifesto id; warrant id] tuple is created. MDF 506 forwards to the DDDFI 524 or 526 all of the signaling for the same session. The DDDFI 524 or 526 buffers and reorder received signaling based on the provided manifesto. At triggering stop detection the DDDF 510 delivers ordered signaling to the LEA 512 and notifies the HM 508 via “service_sequence_order” parameter. Finally, HM 508 deallocate the specific DDDFI 524 or 526.

Furthermore, it could happen that a communication service can change: for example, a user starts a SIP basic call towards a destination and the call is forwarded to another destination based on a service setting (No Answer, Unconditional, Busy, etc.).

In such a case, once a new service logic is detected on a current session where a DDDF instance is on charge, HM 508 provide a new service manifesto to the DDDFI 524 or 526.

The proposed “service sequence order” function is activated via a global property affecting all warrants or also at warrant basis as ETSI TS 103 120 V1.11.2 (2022-05) defines for a LI task object its target identifier by its value and the type of service(s) to intercept. The list is modified with specific network service after a proper analysis aiming to detect relative triggering events. When activated on warrant base by HI1, ADMF will act by ETSI X1 (clause 4.1.4 ETSI TS 103 221-1 V1.12.1 (2022-08)) to notify directly HM 508 to activate DDDF 510 at LIID level.

The activation of the DDDF function is proposed to be implemented based on the standard procedures of the TS 103 120 at a CREATE Request from LEMF 110, ETSI TS 103 120 V1.11.2 (2022-05), by extending the HI-1 Object definition (ref. clause 7.1, ETSI TS 103 120 V1.11.2 (2022-05)) in a backward compatible way. Specifically, the field TaskDeliveryDetails (clause 8.2.8, ETSI TS 103 120 V1.11.2 (2022-05)) is extended in the Delivery Profile field of the DeliveryDestination by including a new set of Buffering activation details. Such a new warrant data is notified on X1 by ADMF towards MF to inform HM.

When requesting from LEA 512 to create (or modify) a new task on HI1, CSP (specifically) ADMF, in case of the request to manage such task with buffered delivery on HI, will additionally interact with the Mediation Function (ref. clause 4.1.4 of ETSI TS 103 221-1 V1.12.1 (2022-08)) via X1 to notify MF/DF that for such a request (identified by XID for identified targets) a specific new buffered Delivery Type has to be applied. This new Delivered Type is proposed to be added to the already existing X1 standard parameter values to maintain the backward compatibility.

When an interception occurs, PoI 106 provides intercepted events on X interface to HM 508 which verifies the interception is authorized before forward to the LEA 512 over Handover Interface. When an intercepted event is detected as triggering events start for a warrant in the network service list among the service manifesto, HM activates the logic by enabling DDDF 510.

DDDF 510 buffers all events including the triggering events start until the reception of triggering event stop. Intercepted and buffered data is delivered as soon as the triggering event stop is received for the specific warrant and network service interception, or a pre-defined time out exceeds for the specific service. The proposed logic let HM guarantees the service events sequence in the same order as received on X interface from PoI 106.

HI interface is enriched with an additional and optional parameter, “service_sequence_order”, to notify the LEA 512 about the data processing at the MDF level.

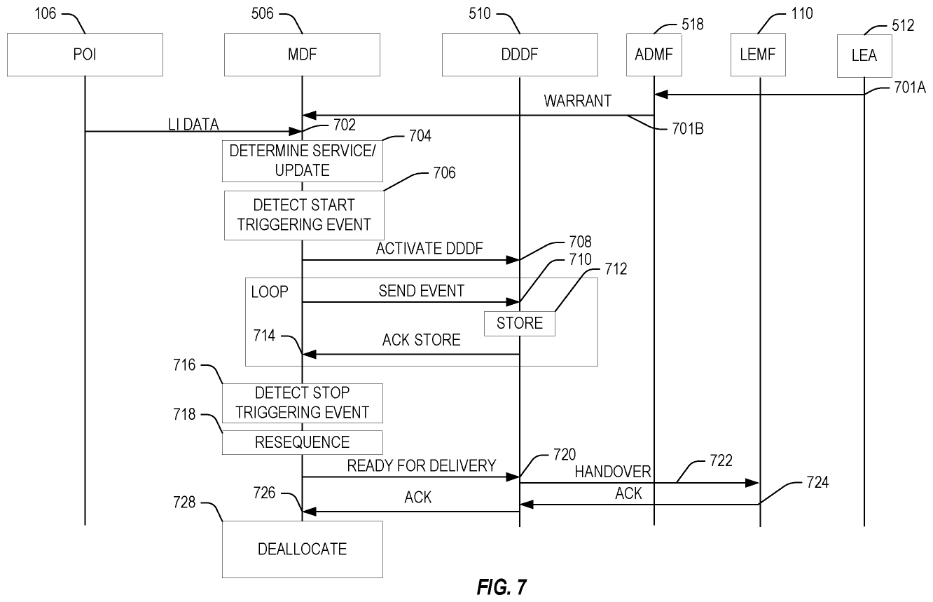

FIG. 7 illustrates a message sequence chart for LI data resequencing and handover according to some embodiments of the present disclosure. In an embodiment, the LEMF 110 and the LEA 512 are in the law enforcement domain, while the PoI 106, the MDF 506, the DDDF 528, and the ADFM 518 are in the communication system domain.

The LEA 512 can provide the warrant 528 to the ADMF 518 at step 701B, and the ADFM 518 can forward the warrant 528 to the MDF 506 at 701B. The PoI 106 can separately be configured by the ADMF 518, and the PoI 106 can then provide the LI data to the MDF 506 at step 702. The LI Data provided to the MDF 506 can comprise the messages associated with the respective communication service. For example, for LI data associated with a call, the LI data can include the message of the message sequence chart sent between device 1 402 and device 2 404 as depicted in FIG. 4. For example, for a Call Forward use case the LI Data can include the following messages in the following order without being resequenced: “invite, 180 ringing, 200 ok, ack, 181 Call Forward, invite, 487, 180 ringing, 200 ok, ack, bye, 200 ok. To provide the LI data, the PoI 106 can open a transport layer security (TLS) over a transport control protocol (TCP) connection to perform mutual authentication and identification between the PoI 106 and MDF 506. On this connection the PoI 106 sends data to the MDF 506 as a binary stream of X2/X3 PDUs as described in Chapter 5 of ETSI TS 103 221-2 V1.6.1 document. The LI data sent in 702 can be in the form of X2 messages (LI data as SIP messages) that are included as payload in a PDU structure as described in Table 1 in Chapter 5 of ETSI TS 103 221-2 V1.6.1 document.

At step 704, the MDF 506 can determine the communication session of the communication service based on the correlation information received from the one or more PoI (106), wherein the correlation information comprises metadata identifying services, events, and nodes associated with the communication session. The warrant 528 can also include the correlation information. The MDF 506 can also update the service manifesto if a new communication service or logic is detected.

At step 706, the MDF 506 can determine that a start triggering event has occurred. The MDF 506 can determine this based on a service manifest associated with the communication service or based on one or more specific events occurring related to the communication service. For example, the service manifest can include the list of events associated with the communication service, and their relative sequencing. If a message is received out of sequence, the MDF 506 can determine that the start triggering event has occurred.

At 708, the MDF 506 can instruct the DDDF 528 to begin buffering the LI Data in a DDDF instance. The MDF 506 can then, repeatedly send the LI data to the DDDF 528 at step 710 for the DDDF 528 to store the data at 712, and then send an acknowledgment back to the MDF 506 at step 714 until at step 716, the MDF 506 detects that a stop triggering event has occurred.

Like the start triggering event, the MDF 506 can determine that a stop triggering event has occurred based on a service manifest associated with the communication service or based on one or more specific events occurring related to the communication service. For example, the service manifest can include the list of events associated with the communication service, and their relative sequencing. If a message is received in sequence, the MDF 506 can determine that the stop triggering event has occurred, and no longer send data to be stored by the DDDF 528.

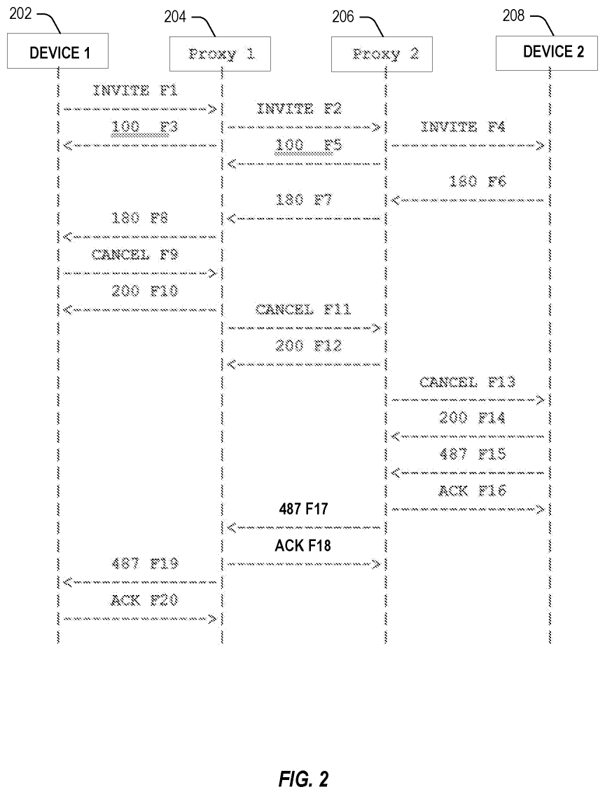

At 718, the MDF 506 can reorder the buffered data in the DDDFI based on the service manifest, and then instruct the DDDF 528 at step 720 to initiate handover of the buffered and resequenced LI data to the LEMF 110 at step 722. The resequenced LI data can comprise the messages that were received in step 702, except the messages that were out of order can be resequenced. After buffering and resequencing, the resequenced LI data can comprise the messages in the following order: “invite, 180 ringing, 200 ok, 487 (start event), ack*, 181 Call Forward*, invite*, 180 ringing*, 200 ok* (stop event), ack, bye, 200 ok” where the asterisk denotes a message that has been resequenced. The handover interface that provides the resequenced LI data to the LEMF 110 is based on a TCP connection where MDF 506 is the TCP sender and the LEMF 110 is the TCP receiver as described in paragraph 6.4 of ETSI TS 102 232-1 V3.27.1 document. The LI data is sent as SIP messages, provided at the application layer, and is included as an Intercept Related Parameter (IRI) parameter of ETSI TS 102 232-5 V3.16.1 and ETSI TS 102 232-7 V3.12.1 in the base structure and reported as described in FIG. 2 of paragraph 4.3 of ETSI TS 102 232-1 V3.27.1 document. The LEMF 110 can then send an acknowledgement at step 724 and 725 back to the MDF 506 via the DDDF 528. Once the LI data is transferred, the MDF 506 can deallocate the DDDFI at step 728.

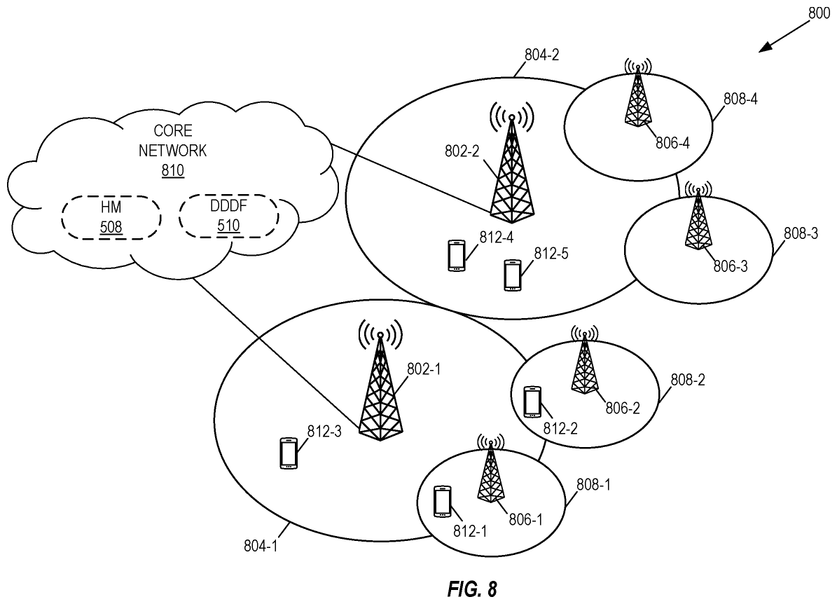

FIG. 8 illustrates one example of a cellular communications system 800 in which embodiments of the present disclosure may be implemented. In the embodiments described herein, the cellular communications system 800 is a 5G system (5GS) including a Next Generation Radio Access Network (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 802-1 and 802-2, [which in the 5GS include NR base stations (gNBs) and optionally next generation eNBs (ng-eNBs) (e.g., Long Term Evolution (LTE) RAN nodes connected to the 5GC) and in the EPS include eNBs, controlling corresponding (macro) cells 804-1 and 804-2. The base stations 802-1 and 802-2 are generally referred to herein collectively as base stations 802 and individually as base station 802. Likewise, the (macro) cells 804-1 and 804-2 are generally referred to herein collectively as (macro) cells 804 and individually as (macro) cell 804. The RAN may also include a number of low power nodes 806-1 through 806-4 controlling corresponding small cells 808-1 through 808-4. The low power nodes 806-1 through 806-4 can be small base stations (such as pico or femto base stations) or Remote Radio Heads (RRHs), or the like. Notably, while not illustrated, one or more of the small cells 808-1 through 808-4 may alternatively be provided by the base stations 802. The low power nodes 806-1 through 806-4 are generally referred to herein collectively as low power nodes 806 and individually as low power node 806. Likewise, the small cells 808-1 through 808-4 are generally referred to herein collectively as small cells 808 and individually as small cell 808. The cellular communications system 800 also includes a core network 810, which in the 5G System (5GS) is referred to as the 5GC. The base stations 802 (and optionally the low power nodes 806) are connected to the core network 810. The core network 810 can include the HM 508 and the DDDF 510 that are disclosed herein, and provide the functionality described of buffering LI data and resequencing the buffered LI data before handing over the LI data to the Law Enforcement domain.

The base stations 802 and the low power nodes 806 provide service to wireless communication devices 812-1 through 812-5 in the corresponding cells 804 and 808. The wireless communication devices 812-1 through 812-5 are generally referred to herein collectively as wireless communication devices 812 and individually as wireless communication device 812. In the following description, the wireless communication devices 812 are oftentimes UEs, but the present disclosure is not limited thereto.

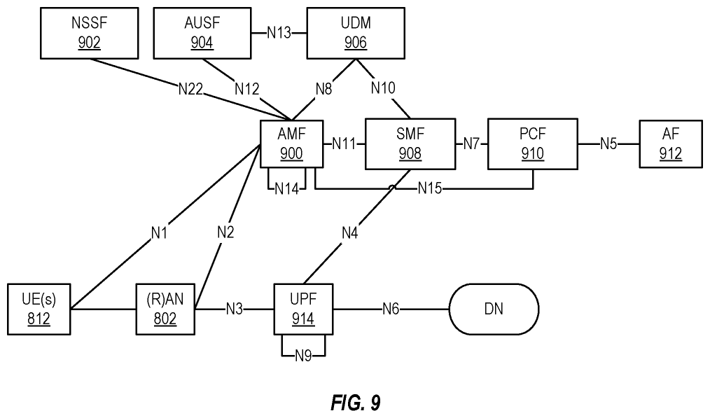

FIG. 9 illustrates a wireless communication system represented as a 5G network architecture composed of core Network Functions (NFs), where interaction between any two NFs is represented by a point-to-point reference point/interface.

FIG. 9 can be viewed as one particular implementation of the system 800 of FIG. 8.

Seen from the access side the 5G network architecture shown in FIG. 9 comprises a plurality of UEs 812 connected to either a RAN 802 or an Access Network (AN) as well as an AMF 900. Typically, the R (AN) 802 comprises base stations, e.g., such as eNBs or gNBs or similar. Seen from the core network side, the 5GC NFs shown in FIG. 9 include a NSSF 902, an AUSF 904, a UDM 906, the AMF 900, a SMF 908, a PCF 910, and an Application Function (AF) 912.

Reference point representations of the 5G network architecture are used to develop detailed call flows in the normative standardization. The N1 reference point is defined to carry signaling between the UE 812 and AMF 900. The reference points for connecting between the AN 802 and AMF 900 and between the AN 802 and UPF 914 are defined as N2 and N3, respectively. There is a reference point, N11, between the AMF 900 and SMF 908, which implies that the SMF 908 is at least partly controlled by the AMF 900. N4 is used by the SMF 908 and UPF 914 so that the UPF 914 can be set using the control signal generated by the SMF 908, and the UPF 914 can report its state to the SMF 908. N9 is the reference point for the connection between different UPFs 914, and N14 is the reference point connecting between different AMFs 900, respectively. N15 and N7 are defined since the PCF 910 applies policy to the AMF 900 and SMF 908, respectively. N12 is required for the AMF 900 to perform authentication of the UE 812. N8 and N10 are defined because the subscription data of the UE 812 is required for the AMF 900 and SMF 908.

The 5GC network aims at separating UP and CP. The UP carries user traffic while the CP carries signaling in the network. In FIG. 9, the UPF 914 is in the UP and all other NFs, i.e., the AMF 900, SMF 908, PCF 910, AF 912, NSSF 902, AUSF 904, and UDM 906, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 900 and SMF 908 are independent functions in the CP. Separated AMF 900 and SMF 908 allow independent evolution and scaling. Other CP functions like the PCF 910 and AUSF 904 can be separated as shown in FIG. 9. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

FIG. 10 illustrates a 5G network architecture using service-based interfaces between the NFs in the CP, instead of the point-to-point reference points/interfaces used in the 5G network architecture of FIG. 9. However, the NFs described above with reference to FIG. 9 correspond to the NFs shown in FIG. 10. The service(s) etc. that a NF provides to other authorized NFs can be exposed to the authorized NFs through the service-based interface. In FIG. 10 the service based interfaces are indicated by the letter “N” followed by the name of the NF, e.g., Namf for the service based interface of the AMF 900 and Nsmf for the service based interface of the SMF 908, etc. The NEF 1000 and the NRF 1002 in FIG. 10 are not shown in FIG. 9 discussed above. However, it should be clarified that all NFs depicted in FIG. 9 can interact with the NEF 1000 and the NRF 1002 of FIG. 10 as necessary, though not explicitly indicated in FIG. 9.

Some properties of the NFs shown in FIGS. 9 and 10 may be described in the following manner. The AMF 900 provides UE-based authentication, authorization, mobility management, etc. A UE 812 even using multiple access technologies is basically connected to a single AMF 900 because the AMF 900 is independent of the access technologies. The SMF 908 is responsible for session management and allocates Internet Protocol (IP) addresses to UEs. It also selects and controls the UPF 914 for data transfer. If a UE 812 has multiple sessions, different SMFs 908 may be allocated to each session to manage them individually and possibly provide different functionalities per session. The AF 912 provides information on the packet flow to the PCF 910 responsible for policy control in order to support Quality of Service (QoS). Based on the information, the PCF 910 determines policies about mobility and session management to make the AMF 900 and SMF 908 operate properly. The AUSF 904 supports authentication function for UEs or similar and thus stores data for authentication of UEs or similar while the UDM 906 stores subscription data of the UE 812. The Data Network (DN), not part of the 5GC network, provides Internet access or operator services and similar. The NFs also include the DDDF 510 and the HM 508 as described herein.

An NF may be implemented either as a network element on a dedicated hardware, as a software instance running on a dedicated hardware, or as a virtualized function instantiated on an appropriate platform, e.g., a cloud infrastructure.

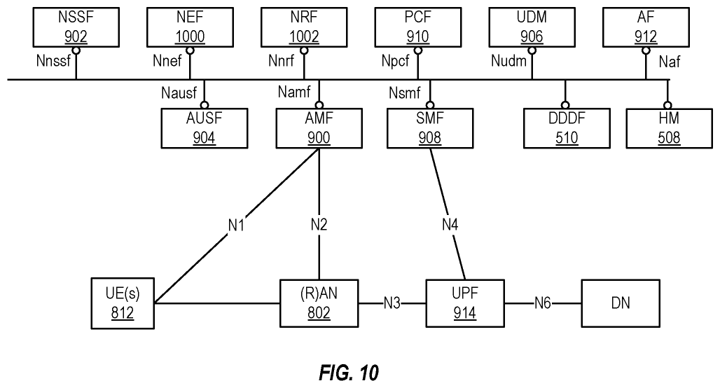

FIG. 11 is a schematic block diagram of a network node 1100 according to some embodiments of the present disclosure. Optional features are represented by dashed boxes. The network node 1100 may be, for example, a core network node 810. As illustrated, the network node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. The one or more processors 1104 operate to provide one or more functions of a network node 1100 as described herein. In some embodiments, the function(s) are implemented in software that is stored, e.g., in the memory 1106 and executed by the one or more processors 1104.

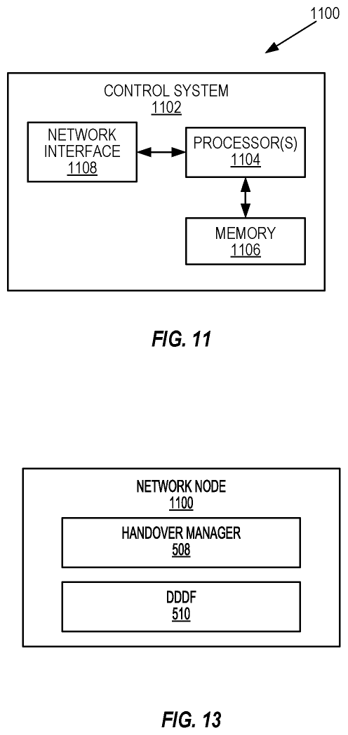

FIG. 12 is a schematic block diagram that illustrates a virtualized embodiment of the network node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 1100 in which at least a portion of the functionality of the network node 1100 is implemented as a virtual component(s) (e.g., via a virtual machine(s) executing on a physical processing node(s) in a network(s)). As illustrated, in this example, the network node 1100 may include the control system 1102 as described above. The network node 1100 includes one or more processing nodes 1200 coupled to or included as part of a network(s) 1202. If present, the control system 1102 is connected to the processing node(s) 1200 via the network 1202. Each processing node 1200 includes one or more processors 1204 (e.g., CPUs, ASICs, FPGAs, and/or the like), memory 1206, and a network interface 1208.

In this example, functions 1210 of the network node 1100 described herein are implemented at the one or more processing nodes 1200 or distributed across the one or more processing nodes 1200 and the control system 1102 in any desired manner. In some particular embodiments, some or all of the functions 1210 of the network node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

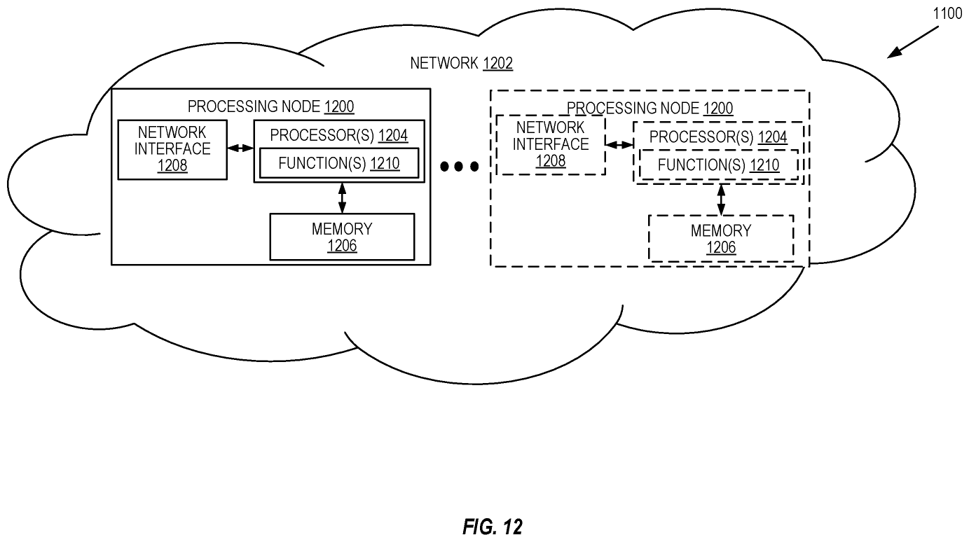

FIG. 13 is a schematic block diagram of the network node 1100 according to some other embodiments of the present disclosure. The network node 1100 includes one or more modules such as HM 508 and DDDF 510, each of which is implemented in software. The module(s) 1300 provide the functionality of the network node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ADMF Administration Function
AF
Application Function
Access and Mobility Function
AMF
AN Access Network
ASIC Application Specific Integrated Circuit
AUSF Authentication Server Function
CID Communication Identifier
CPU Central Processing Unit
CSP Communications Service Provider
DDDF Delayed Data Delivery Function
DF Delivery Function
DN Data Network
DSP Digital Signal Processor
eNB Enhanced or Evolved Node B
EPS Evolved Packet System
ETSI
European Telecommunications Standards Institute
Evolved Universal Terrestrial Radio Access
E-UTRA
FPGA Field Programmable Gate Array
gNB New Radio Base Station
HI Handover Interface
HM Handover Manager
HSS Home Subscriber Server
IP
Internet Protocol
Intercept Related Information
IRI
LEA Law Enforcement Agency
LEMF Law Enforcement Monitoring Function
LI Lawful Intercept
LIID Lawful Interception Identifier
LTE
Long Term Evolution
Mediation and Delivery Function
MDF
MME
Mobility Management Entity
Network Exposure Function
NEF
NF Network Function
NR New Radio
NRF
Network Function Repository Function
Network Slice Selection Function
NSSF
PCF Policy Control Function
P-GW
POI
Packet Data Network Gateway
Points of Interception
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
TS Technical Specification
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method for handing over lawful intercept (LI) data to a Law Enforcement Monitoring Function (LEMF) of a Law Enforcement Agency (LEA) and being performed by a handover manager (HM) of a core network, the method comprising:
receiving LI data comprising information about a plurality of events associated with a communication session of a communication service, from one or more Points of Interception (PoI);
determining that a start triggering event has occurred based on the LI data;
buffering the LI data resulting in buffered LI data until a stop triggering event has occurred;
resequencing the plurality of events of the buffered LI data based on a service manifesto associated with the communication service, resulting in resequenced buffered LI data; and
handing over the resequenced buffered LI data to the LEMF.

2. The method of claim 1, further comprising:
determining the communication session of the communication service based on correlation information received from the one or more PoI, wherein the correlation information comprises metadata identifying services, events, and nodes associated with the communication session.

3-7. (canceled)

8. The method of claim 1, further comprising:
wherein the receiving the LI data is in response to receiving a warrant from an Administration Function (ADMF), the warrant comprising at least one of target information, communication service information, or priority information.

9. The method of claim 1, wherein the start triggering event is based on determining that an event of the plurality of events is received out of sequence based on the service manifesto associated with the communication service.

10. The method of claim 1, wherein the start triggering event is a predefined event associated with the communication service.

11. The method of claim 1, wherein the stop triggering event is based on determining that an event of the plurality of events subsequent to the start triggering event of the plurality of events is received in sequence based on the service manifesto.

12. The method of claim 1, wherein the stop triggering event is another predefined event associated with the communication service that is received subsequent to the start triggering event.

13. A network node for implementing a handover manager for a core network, is configured to hand over lawful intercept (LI) data to a Law Enforcement Monitoring Function (LEMF) of a Law Enforcement Agency (LEA), the network node comprising processing circuitry configured to cause the network node to:
receive LI data comprising information about a plurality of events associated with a communication session of a communication service, from one or more Points of Interception (PoI);
determine that a start triggering event has occurred based on the LI data;
buffer the LI data resulting in buffered LI data until a stop triggering event has occurred;
resequence the plurality of events of the buffered LI data based on a service manifesto associated with the communication service, resulting in resequenced buffered LI data; and
hand over the resequenced buffered LI data to the LEMF.

14. The network node of claim 13, wherein the processing circuitry is further configured to:
determine the communication session of the communication service based on correlation information received from the one or more PoI, wherein the correlation information comprises metadata identifying services, events, and nodes associated with the communication session.

15. The network node of claim 13, wherein the processing circuitry is further configured to:
buffer the LI data in a Delayed Data Delivery Function (DDDF) instance.

16. The network node of claim 15, wherein the processing circuitry is further configured to:
buffering LI data from a plurality of communication sessions in respective DDDF instances.

17. The network node of claim 15, wherein the processing circuitry is further configured to:
deallocate the DDDF instance subsequent to handing over the resequenced buffered LI data.

18. The network node of claim 17, wherein the deallocating the DDDF instance is in response to receiving an acknowledgement receipt from the LEMF.

19. The network node of claim 15, wherein the processing circuitry is further configured to:
update the service manifesto of the DDDF instance based on detecting a new communication service associated with the communication session.

20. The network node of claim 13, wherein the receiving the LI data is in response to receiving a warrant from an Administration Function (ADMF), the warrant comprising at least one of target information, communication service information, or priority information.

21. The network node of claim 13, wherein the start triggering event is based on a determination that an event of the plurality of events is received out of sequence based on the service manifesto associated with the communication service.

22. The network node of claim 13, wherein the start triggering event is a predefined event associated with the communication service.

23. The network node of claim 13, wherein the stop triggering event is based on determining that an event of the plurality of events subsequent to the start triggering event of the plurality of events is received in sequence based on the service manifesto.

24. The network node of claim 13, wherein the stop triggering event is another predefined event associated with the communication service that is received subsequent to the start triggering event.

25. A non-transitory computer-readable storage medium that includes executable instructions to cause a processor device of a network node implementing a handover manager of a core network to:
receive Lawful Intercept (LI) data comprising information about a plurality of events associated with a communication session of a communication service, from one or more Points of Interception (PoI);
determine that a start triggering event has occurred based on the LI data;
buffer the LI data resulting in buffered LI data until a stop triggering event has occurred;
resequence the plurality of events of the buffered LI data based on a service manifesto associated with the communication service, resulting in resequenced buffered LI data; and
hand over the resequenced buffered LI data to a Law Enforcement Monitoring Function (LEMF).
